(19) United States
(12) Patent Application Publication
(10) Pub. No.: US 2025/0288499 A1
(43) Pub. Date: Sep. 18, 2025

(54) NASOGASTRIC TUBE WITH RETAINERS

(71) Applicant: KING SAUD UNIVERSITY, RIYADH (SA)

(72) Inventors: NORA FAHAD ALSUDAIRI, RIYADH (SA); SHAHAD HUSSIEN ALSAFHI, RIYADH (SA)

(21) Appl. No.: 18/915,712

(22) Filed: Oct. 15, 2024

Related U.S. Application Data
(63) Continuation-in-part of application No. 18/607,132, filed on Mar. 15, 2024, now abandoned.

(51) Int. Cl. A61J 15/00

(52) U.S. Cl. CPC A61J 15/0003; A61J 15/0049

(57) ABSTRACT

The nasogastric tube with retainers includes a nasogastric tube, a hook, an inflatable balloon and an inflation tube. The nasogastric tube has opposed first and second open ends, and the hook is secured to the nasogastric tube adjacent the first end thereof. The hook is adapted for releasable attachment to the patient's ear. The inflatable balloon is secured to the nasogastric tube adjacent the second end thereof such that, following insertion, the second end of the nasogastric tube and the inflatable balloon are positioned in the patient's stomach. The inflation tube is secured to the nasogastric tube and extends parallel thereto. The inflation tube has opposed first and second ends, with the second end thereof being in open fluid communication with an interior of the inflatable balloon.

### BACKGROUND OF THE INVENTION

### Field of the Invention

The disclosure of the present patent application relates to medical equipment, and particularly to a nasogastric tube with retaining features to prevent premature removal of the nasogastric tube.

### Description of Related Art

A nasogastric (NG) tube is a tube used in medical practice for carrying food and medicine to a patient's stomach through the nose. Once an NG tube is in place, healthcare providers can deliver food and medicine directly to the stomach or remove substances therefrom. As shown in FIG. 2, a typical NG tube 100 is inserted through the patient's nose N until one end 104 of the tube 100 is positioned within the patient's stomach S. The end 104 travels to the stomach S via the patient's esophagus E. The other end 102 of the tube remains outside the body, where end 102 may be attached to, for example, a drip bag for supplying food or medicine under the force of gravity.

In use, the external portion of tube 100 is typically looped over the patient's ear and taped in place, often on the patient's cheek. For patients who are coming out of sedation and are groggy, for example, the presence of the NG tube can be upsetting and the patient may try to manually remove the tube 100, not realizing what he or she is doing. Since the typical NG tube is held in place by nothing more than tape, there is little to prevent the patient from prematurely removing the tube. Thus, a nasogastric tube with retainers solving the aforementioned problems is desired.

### SUMMARY OF THE INVENTION

The nasogastric tube with retainers includes a nasogastric tube, a hook and an inflatable balloon. The nasogastric tube has opposed first and second open ends, and the hook is secured to the nasogastric tube adjacent the first end thereof. Following insertion of the nasogastric tube, the first end remains external to the patient for connection to, for example, a drip bag for feeding the patient. The hook is adapted for releasable attachment to the patient's ear. A channel may be formed through the hook. The channel may be internal to the hook and extend throughout an entire length of the hook. The nasogastric tube may partially pass through the channel, such that a portion of the nasogastric tube is entirely surrounded by the hook. In this way, the hook may be mounted on and entirely surround a portion of the nasogastric tube, adjacent the first open end thereof. The inflatable balloon is secured to the nasogastric tube adjacent the second end thereof such that, following insertion, the second end of the nasogastric tube and the inflatable balloon are positioned in the patient's stomach. An inflation tube is secured to the nasogastric tube and extends parallel thereto. The inflation tube has opposed first and second ends, with the second end thereof being in open fluid communication with an interior of the inflatable balloon. Following insertion, the first end of the inflation tube remains external to the patient for transferring fluid to the inflatable balloon for the inflation thereof or for draining the fluid from the inflatable balloon for deflation thereof.

In use, the second open end of the nasogastric tube is inserted into the stomach of the patient via the patient's nose and esophagus in a manner similar to the placement of a conventional nasogastric tube. Once the second end is located in the stomach, the inflatable balloon is inflated to hold the second end within the patient's stomach. The hook is releasably attached to the patient's ear to secure the external portion of the nasogastric tube to the patient. When it is time to remove the nasogastric tube, the inflatable balloon is deflated and the hook is unhooked from the patient's ear.

These and other features of the present subject matter will become readily apparent upon further review of the following specification.

### BRIEF DESCRIPTION OF DRAWINGS

FIG. 1 is a front view of the nasogastric tube with retainers.

FIG. 2 illustrates insertion of a conventional nasogastric tube.

FIG. 3 is a cross-sectional view of the nasogastric tube and a hook, taken alone cross-sectional cut lines 3-3 of FIG. 1.

Similar reference characters denote corresponding features consistently throughout the attached drawings.

### DETAILED DESCRIPTION

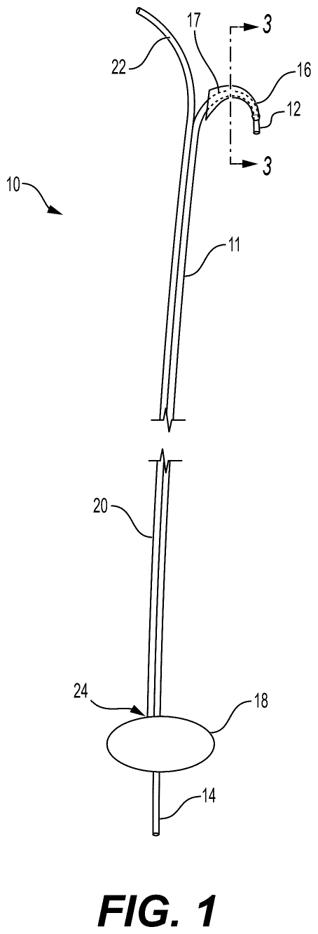

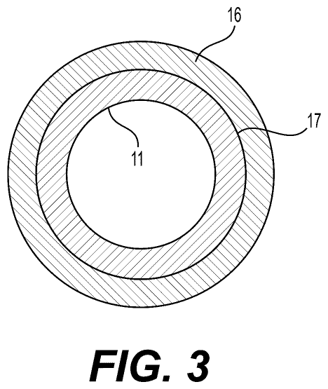

The nasogastric tube with retainers 10 includes a nasogastric tube 11, a hook 16 and an inflatable balloon 18. The nasogastric tube 11 is similar to a conventional nasogastric tube, including opposed first and second open ends 12, 14, respectively. It should be understood that the nasogastric tube 11 is shown in FIG. 1 for exemplary purposes only and that nasogastric tube 11 may be any suitable type of nasogastric tube or similar medical equipment. The hook 16 is secured to the nasogastric tube 11 adjacent the first open end 12. As shown in FIG. 1, the hook 16 may have a channel 17 formed therethrough, such that the nasogastric tube 11 passes through the channel 17; i.e., the hook 16 is mounted on and surrounds the nasogastric tube 11, adjacent the first open end 12. As best seen in FIG. 3, the channel 17 may be entirely internal to the hook 16 and extend from one end of the hook to the other, thus allowing a portion of the nasogastric tube 11 to be entirely circumferentially surrounded by the hook 16.

Following insertion of the nasogastric tube 11 in the conventional manner, the first open end 12 remains external to the patient for connection to, for example, a drip bag for feeding the patient. The hook 16 is adapted for releasable attachment to the patient's ear. It should be understood that hook 16 is shown in FIG. 1 for exemplary purposes only and may be any suitable type of retaining structure for releasable attachment to or around the patient's ear. As a non-limiting example, hook 16 may be similar to the hook used to secure hearing aids in a patient's ear.

The inflatable balloon 18 is secured to the nasogastric tube 11 adjacent the second open end 14 such that, following insertion, the second open end 14 and the inflatable balloon 18 are positioned in the patient's stomach. An inflation tube 20 is secured to the nasogastric tube 11 and extends parallel thereto. The inflation tube 20 has opposed first and second ends 22, 24, respectively, with the second end 24 being in open fluid communication with an interior of the inflatable balloon 18. Following insertion, the first end 22 of the inflation tube 20 remains external to the patient for transferring fluid to the inflatable balloon 18 for the inflation thereof or for draining the fluid from the inflatable balloon 18 for deflation thereof. In an embodiment, the fluid can be saline water. As a further non-limiting example, the saline water may be colored, such as saline water with additional blue dye, to make any leakage visible. It should be understood that inflatable balloon 18 is shown in FIG. 1 for exemplary purposes only and that inflatable balloon 18 may have any suitable shape and relative dimensions. As a non-limiting example, inflatable balloon 18 may be toroidal and be positioned circumferentially about nasogastric tube 11.

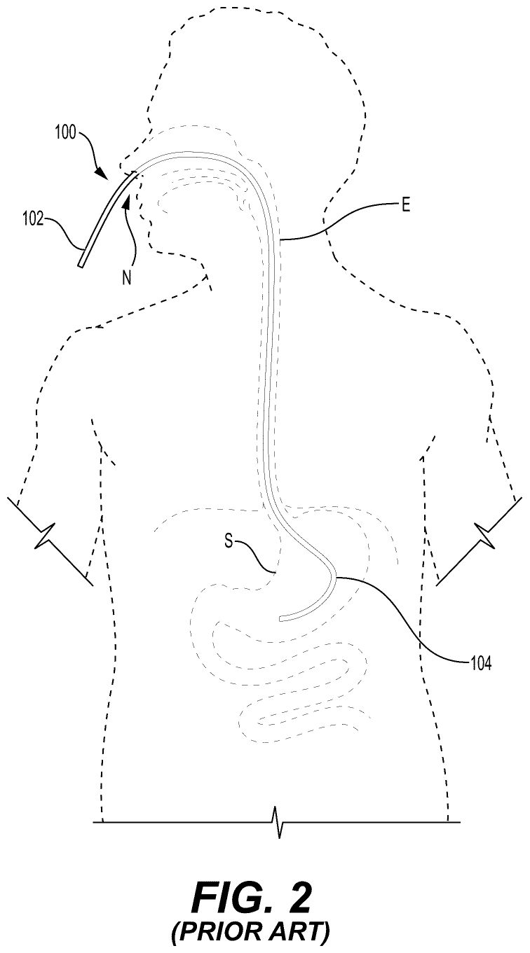

In use, the second open end 14 of the nasogastric tube 11 is inserted into the stomach of the patient via the patient's nose and esophagus in a manner similar to the placement of a conventional nasogastric tube (e.g., in a manner similar to that shown in FIG. 2). Once the second open end 14 is located in the stomach, the inflatable balloon 18 is inflated to hold the second open end 14 within the patient's stomach. The hook 16 is releasably attached to the patient's ear to secure the external portion of the nasogastric tube 11 to the patient. When it is time to remove the nasogastric tube 11, the inflatable balloon 18 is deflated and the hook 16 is unhooked from the patient's ear.

It is to be understood that the nasogastric tube with retainers is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

1. A nasogastric tube with retainers, comprising:
a nasogastric tube having opposed first and second open ends;
a hook secured to the nasogastric tube adjacent the first open end thereof, wherein a channel is formed through the hook, the channel being internal to the hook and extending throughout an entire length of the hook, the nasogastric tube partially passing through the channel, a portion of the nasogastric tube being entirely circumferentially surrounded by the hook, and wherein the hook is adapted for releasable attachment to an ear of a patient;
an inflatable balloon secured to the nasogastric tube adjacent the second open end thereof; and
an inflation tube secured to the nasogastric tube, the inflation tube having opposed first and second ends, the second end thereof being in open fluid communication with an interior of the inflatable balloon, and the first end thereof being adapted for transferring fluid to the inflatable balloon for the inflation thereof or for draining the fluid from the inflatable balloon for deflation thereof.

2. The nasogastric tube with retainers as recited in claim 1, wherein the inflation tube extends parallel to the nasogastric tube.

3. A method of inserting and retaining a nasogastric tube, comprising the steps of:
providing a nasogastric tube having opposed first and second open ends;
feeding the second open end of the nasogastric tube into a stomach of a patient via a nose and esophagus of the patient;
inflating an inflatable balloon when the second open end is in the stomach of the patient, the inflatable balloon being secured to the nasogastric tube adjacent the second end thereof; and
releasably attaching a hook to an ear of the patient, the hook being secured to the nasogastric tube adjacent the first end thereof, wherein a channel is formed through the hook, the channel being internal to the hook and extending throughout an entire length of the hook, the nasogastric tube partially passing through the channel, a portion of the nasogastric tube being entirely circumferentially surrounded by the hook.

4. The method of inserting and retaining a nasogastric tube as recited in claim 3, wherein the step of inflating the inflatable balloon comprises transferring fluid to the inflatable balloon for the inflation thereof.

5. The method of inserting and retaining a nasogastric tube as recited in claim 4, wherein the fluid is saline water.

6. The method of inserting and retaining a nasogastric tube as recited in claim 5, wherein the fluid is colored.
